(19) United States
(12) Patent Application Publication
(10) Pub. No.: US 2023/0401485 A1
(43) Pub. Date: Dec. 14, 2023

(54) Apparatus And Method For Optimizing, Monitoring And Controlling A Real Physical System

(71) Applicant: Cambridge Quantum Computing Limited, London (GB)

(72) Inventors: Luuk COOPMANS, Oxford (GB); Yuta KIKUCHI, Tokyo (JP); Marcello BENEDETTI, Kaunas (LT); Mattia FIORENTINI, London (GB)

(73) Assignee: Cambridge Quantum Computing Limited, London (GB)

(21) Appl. No.: 18/201,410

(22) Filed: May 24, 2023

(30) Foreign Application Priority Data
Jun. 10, 2022 (GB) 2208524.5

(51) Int. Cl. G06N 20/00; G06N 7/01; G06N 10/40

(52) U.S. Cl. CPC G06N 20/00; G06N 7/01; G06N 10/40

(57) ABSTRACT

There is provided a method and apparatus for at least one of optimizing, monitoring and controlling a real physical system. Data representative of the physical system are obtained and used to generate one or more Hamiltonians. These Hamiltonians, in turn, are used in a quantum signal processing circuit of a quantum computer to simulate imaginary time evolution of a thermal pure quantum (TPQ) state of a collection of qubits that represent a Gibbs state of the system. Optionally, a Bayesian machine may be trained based on the evolution of the TPQ state to predict behavior of the physical system over time. Classical shadow tomography is then used to provide a classical representation of a TPQ state to a classical computer, to thereby facilitate classical optimization or control of the real physical system.

### CROSS-REFERENCE TO RELATED APPLICATIONS

This application claims the benefit of Application No. GB2208524.5, filed in the English language in the United Kingdom on Jun. 10, 2022. The entire contents of that application are incorporated herein by reference.

### BACKGROUND OF THE INVENTION

The present disclosure relates to apparatus and method for at least one of optimizing, monitoring and controlling a real physical system; optionally, the apparatus and methods are implemented using quantum computing resources. Moreover, the present disclosure relates to software products that are executable on the apparatus to implement aforesaid methods.

It is known to use mathematical models of real physical systems for at least one of monitoring, optimizing and controlling a real physical system. Often, real physical systems can only be approximately defined from studying their component elements, such that it is often necessary to collect data representing operation of the real physical systems to be able to define their operating characteristics more accurately. Moreover, the systems often have different modes in which they can operate, such that their operating characteristics vary depending on their operating modes in use. Thus, control systems for real physical systems such as aircraft, chemical production facilities, manufacturing facilities, nuclear power facilities, financial systems and so forth need to have the real physical systems represented by a mathematical model before the control systems can accurately monitor, optimize and control the real physical systems. However, collating large amounts of data from real physical systems can often be costly and time-consuming, and even not practicable in many situations.

Various types of mathematical models are feasible and can be generated using, for example, Bayesian machines. However, there are many different feasible implementations for Bayesian machines, for example Boltzmann machines, Born machines, and Ising machines among others. However, deriving parameters for the mathematical models from data collected from operation of real physical systems is a non-trivial computational task, especially when the real physical systems are highly complex in their respective manners of operation.

### SUMMARY OF DISCLOSED EMBODIMENTS

The present disclosure seeks to provide improved apparatus for generating one or more mathematical models describing a given real physical system from data that are representative of operation of the given real physical system, wherein the one or more mathematical models may be used for at least one of monitoring, optimizing and controlling the given real physical system.

According to a first aspect, there is provided an apparatus for at least one of optimizing, monitoring and controlling a real physical system, wherein the apparatus includes a hybrid computing arrangement including one or more classical computers coupled to one or more quantum computers, wherein the one or more quantum computers are configured to execute one or more quantum circuits that are configured using the one or more classical computers, wherein the apparatus is configured in use to:
(i) obtain data that are representative of operation of the real physical system;
(ii) use the data to generate one or more Hamiltonians to define at least one quantum circuit that is executable on the one or more quantum computers, wherein observables (M) obtained from executing the at least one quantum circuit are representative of Gibbs states (namely, statistical distributions) and wherein generation of the observables (M) includes using a combination of thermal pure quantum (TPQ) states and classical shadow tomography;
(iii) train a computational machine based on the observables (M) representative of the Gibbs states;
(iv) generate a mathematical model representative of the real physical system including the computational machine; and
(v) apply the mathematical model to data obtained from the real physical system for generating at least one of:
   (a) a monitoring output that is representative of an operating state or operating condition of the real physical system;
   (b) one or more inputs to an optimization function applied to the mathematical model to generate values of parameters to use to operate the real physical system in a more optimized manner; and
   (c) one or more inputs to a control function applied to the mathematical model to generate values of parameters to use to control operation of the real physical system.

Embodiments are of advantage in that, by using a combination of thermal pure quantum (TPQ) states and classical shadow tomography, observables (M) can be obtained from at least one quantum circuit generated from Hamiltonians a describing the real physical system, wherein the observables (M), namely expectation values, generated from executing the at least one quantum circuits are representative of theoretical Gibbs states; by using thermally pure quantum (TPQ) states and classical shadow tomography, the at least one quantum circuit uses fewer qubits, fewer observables (M) and is shallower when providing computations results to generate the mathematical model. Such an advantage enables the apparatus to train the computational machine, for example implemented as a quantum Boltzmann machine in a far more computationally efficient manner.

An observable is a measurable property of a physical system, so if it is wished to measure, say free energy, pressure and temperature, then M=3.

Optionally, the apparatus is configured to generate the thermal pure quantum (TPQ) states by using imaginary time evolution, e^{-βH/2}|ϕ [symbol] of a n-qubit random state |ϕ>.

Optionally, the apparatus is configured to use the classical shadow tomography to construct an efficient classical representation of these TPQ states from outcomes of randomized subset of the observables (M).

Optionally, the apparatus is configured to estimate M Gibbs state expectation values using [symbol] (log) observables of a single prepared TPQ state.

According to a second aspect, there is provided a method for using an apparatus for at least one of optimizing, monitoring and controlling a real physical system, wherein the apparatus includes a hybrid computing arrangement including one or more classical computers coupled to one or more quantum computers, wherein the one or more quantum computers are configured to execute one or more quantum circuits that are configured using the one or more classical computers, wherein the method includes:
(i) obtaining data that are representative of operation of the real physical system;
(ii) using the data to generate one or more Hamiltonians to define at least one quantum circuit that is executable on the one or more quantum computers, wherein observables (M) obtained from executing the at least one quantum circuit are representative of Gibbs states (namely, statistical distributions) and wherein generation of the observables (M) includes using a combination of thermal pure quantum (TPQ) states and classical shadow tomography;
(iii) training a computational machine based on the observables (M) representative of the Gibbs states;
(iv) generating a mathematical model representative of the real physical system including the computational machine; and
(v) applying the mathematical model to data obtained from the real physical system for generating at least one of:
   (a) a monitoring output that is representative of an operating state or operating condition of the real physical system;
   (b) one or more inputs to an optimization function applied to the mathematical model to generate values of parameters to use to operate the real physical system in a more optimized manner; and
   (c) one or more inputs to a control function applied to the mathematical model to generate values of parameters to use to control operation of the real physical system.

Optionally, the method includes using the apparatus to generate the thermal pure quantum (TPQ) states by using imaginary time evolution, e^{-βH/2}|ϕ [symbol] of a n-qubit random state |ϕ [symbol] .

Optionally, the method includes using the classical shadow tomography to construct an efficient classical representation of these TPQ states from outcomes of randomized subset of the observables (M).

Optionally, the method includes estimating M Gibbs state expectation values using [symbol] (log M) observables of a single prepared TPQ state.

According to a third aspect, there is provided a software product that is executable on the computing system of the first aspect to implement the method of the second aspect.

According to a fourth aspect, there is provided a real physical system coupled to the apparatus of the first aspect, wherein the apparatus is configured to use the method of the second aspect to at least one of: monitor, optimize and control operation of the real physical system.

According to a fifth aspect, there is provided a quantum circuit that is configured to compute one or more observables (namely, expectation values) representative of Gibbs states, wherein the quantum circuit is generated from one or more Hamiltonians representative of a real physical system, wherein the observables are arranged to train a quantum Boltzmann machine for use in at least one of monitoring, controlling and optimizing the real physical system, and wherein the observables are generated using a combination of thermal pure quantum (TPQ) states and classical shadow tomography implemented in the quantum circuit.

According to a sixth aspect, there is provided a quantum mechanical apparatus comprising: one or more classical computers coupled to a real physical system; and one or more quantum computers in data communication with the one or more classical computers. The one or more quantum computers comprise a plurality of qubits configured to perform a quantum circuit that includes: (a) a first Clifford circuit configured to randomize a thermal pure quantum state |ϕ [symbol] of the plurality of qubits, (b) a quantum signal processing circuit configured to approximate an imaginary time evolution of |ϕ [symbol] according to one or more Hamiltonians representative of the real physical system, and (c) a second Clifford circuit configured to perform a randomized measurement of |ϕ [symbol] to thereby compute one or more observables representative of Gibbs states. The one or more classical computers are configured to control the real physical system on the basis of the computed one or more observables.

Optionally, the one or more quantum computers further comprise a quantum Bayesian machine coupled to the quantum circuit for training by the one or more computed observables.

Optionally, the quantum Bayesian machine comprises a Boltzmann machine, or a Born machine, or an Ising machine.

Optionally, the one or more quantum computers are configured to provide, to the one or more classical computers, a classical representation of a state of the real physical system by applying classical shadow tomography to the quantum Bayesian machine.

It is appreciated that the concepts, techniques, and structures disclosed herein may be embodied in ways other than those summarized above. Therefore, this summary of embodiments should be viewed as illustrative, rather than limiting.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures.

FIG. 1 is an illustration of a method for applying implementations of the present disclosure for at least one of optimizing, monitoring and controlling a real physical system.

FIG. 2 is there is shown an illustration of an implementation of a computing system pursuant to the present disclosure.

FIG. 3 Top: The classical shadows of a Gibbs state ρ_{β}, here represented as a quantum system (sphere, left-hand side) in thermal equilibrium with its environment, are equal to the classical shadows constructed from a thermal pure quantum state |ψ_{β} [symbol] (sphere, right-hand side). The random measurement direction of the shadows is determined by the Clifford unitary V_{Cl}. Bottom: A circuit diagram of the quantum circuit that implements a pure thermal shadow with quantum signal processing (QSP).

FIG. 4 shows maximum error between the exact Gibbs state expectation values, [symbol] Oⱼ [symbol] =ₜᵣᵤₑ=TrOⱼρ_{β}, and the estimated expectation values [symbol] Oⱼ [symbol] ₑₛₜ for all possible one- and two-qubit Pauli operators Oⱼ. In FIG. 4(a) we estimate the expectation values directly on thermal pure quantum states, |ψ_{β} [symbol] , generated with QSP for different inverse temperatures β as function of the degree of the polynomial approximation. In FIG. 4(b) we compare the errors between shadows constructed directly from the true Gibbs state, ρ_{β}, and shadows constructed from the exact TPQ states and the TPQ states generated with QSP.

FIG. 5 is a flow chart of steps of a method of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

In practice, real physical systems often are too complex to model exactly, so instead various measurable properties (“observables”) are modeled according to a probability distribution that evolves over time. Equilibrium probability distributions that remain invariant under future evolution of the system (i.e. steady-state distributions) are called “Gibbs states” of the system. For example, air temperature of a room may be measured by a thermometer and, at equilibrium, remains invariant over appropriate time scales. Other observables may include, for example, hardness of a material, or engine temperature in a vehicle, or even prices of a commodity. It is contemplated that any real physical system that is sufficiently complex to evade exact modeling for the purpose of predicting its future behavior, nevertheless, admits of observables. One aspect of embodiments of the concepts, techniques, and structures disclosed herein is to determine appropriate mathematical models of those observables, then use those models to predict outcomes and, in some cases, optimize operation of or otherwise control those real physical systems in a feedback loop.

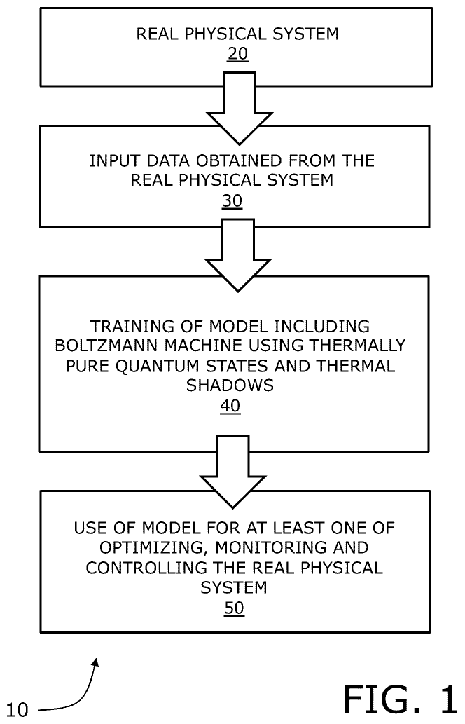

Referring to FIG. 1 there is shown a flow diagram indicated generally by 10. In overview, the flow diagram 10 includes steps 20 to 50 that are required to be executed for efficiently implementing a mathematical model of a given real physical system.

In a first step 20, data is collected that is representative of operation of the given real physical system, for example measurements of its operating parameters as a function of time and its operating mode.

In a second step 30, using a Hamiltonian via a corresponding quantum circuit on a quantum computer, observables (M) of the Hamiltonian at a finite temperature are generated using the quantum computer via use of pure thermal states and thermal shadows (described in more detail below). The observables (M) provide observed values that are representative of probability distributions, for example theoretical Gibbs states. The observables (M) correspond to operation of the real physical system.

In a third step 40, the observables (M) of the Hamiltonian representative of theoretical Gibbs states are used to train a computational machine, for example a quantum Boltzmann machine but not limited thereto, that is representative of the given real physical system, wherein the computational machine is incorporated into a mathematical model to represent the given real physical system.

In a fourth step 50, the mathematical model is used to monitor, optimize, or control the given real physical system. For example, the mathematical model can be used to simulate how the given real physical system operates under various operating conditions, and an optimal manner of operation of the system found from the simulations. Thereafter, the optimal manner of operation can be applied to the given real physical system, for example by controlling its operating settings and parameters, to ensure that the system functions more efficiently or productively (for example, more energy efficient, more input materials efficient, less waste generation and so forth).

Pursuant to the present disclosure, embodiments generate observables (M) representative of the values of theoretical Gibbs states, from quantum circuits derived from the Hamiltonian using pure thermal states and thermal shadows. Computing the Gibbs states directly using the quantum computer is computationally very difficult, and in some cases intractable.

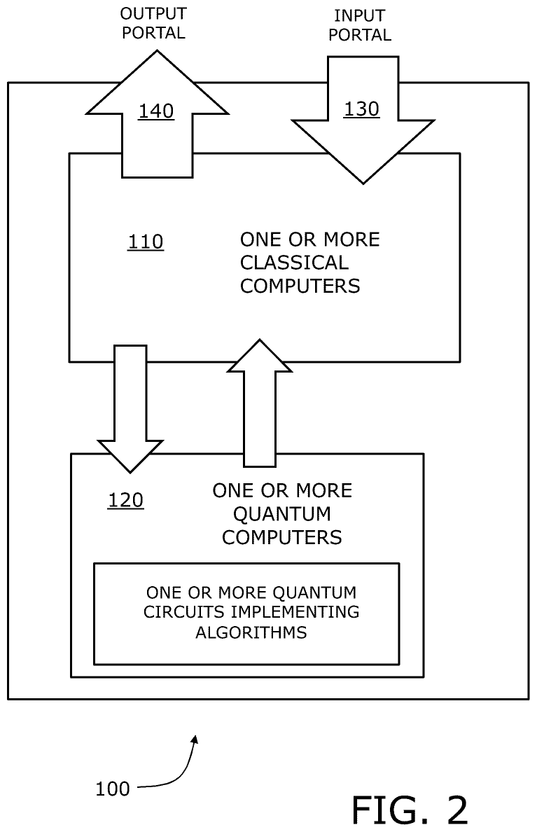

Referring now to FIG. 2, there is shown a quantum computing apparatus indicated generally by 100. The quantum computing apparatus 100 includes one or more classical binary computers 110 coupled to one or more quantum computers 120. The one or more classical binary computers 110 include devices such as reduced instruction set computers (RISC), array processors, graphical processors unit (GPU's), and suchlike, conventionally based on Silicon semiconductor technology. The one or more quantum computers 120 include devices such as cryogenically-cooled Josephson junction (superconducting) quantum processors, trapped-ion quantum processors, photon-based quantum computers or similar. These quantum computers 120 are configured to perform operations on qubits, for example in a range of 2 to 100 qubits, more optionally in a range of 2 to 1000 qubits, or even more optionally in a range of 2 to 1 million qubits as has recently been envisaged. The one or more classical binary computers 110 provide input and output ports 130, 140 for inputting data and outputting data, respectively.

In operation, one or more computing tasks are input via the input port 130 to the one more classical binary computers 110. Amongst other tasks, when in operation, the one or more classical binary computers 110 configure the one or more quantum computers 120 to perform at least a portion of one or more computing tasks that are best suited to being executed using quantum computing. Such configuring includes devising one or more Hamiltonians that are used to generate one or more corresponding quantum circuits (e.g. comprising qubits and quantum logic gates) that are configured via use of the one or more quantum computers 120.

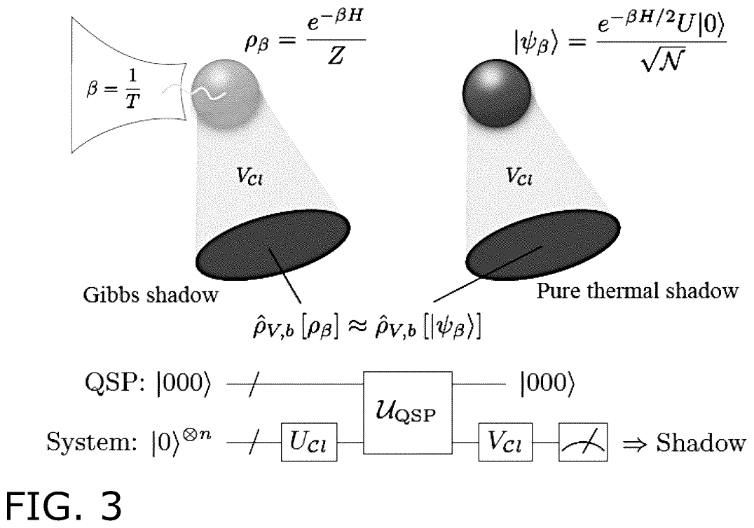

Having described the relevant processes undertaken by embodiments in connection with FIG. 1, and an apparatus with which such processes can be performed in connection with FIG. 2, more detail of programming the apparatus to perform these processes is provided with reference to FIG. 3. In particular, in accordance with the concepts, techniques, and structures disclosed herein, expectation values, namely observables (M) that represent Gibbs states for a real physical system, are computed from thermal pure quantum (TPQ) states of one or more quantum circuits, rather than directly from the Gibbs states themselves. It should be appreciated that configuring a quantum circuit in one or more quantum computers 120 includes altering physical properties of one or more qubits, thereby changing how those qubits react in the presence of each other and the environment according to quantum mechanical principles.

TPQ states are relatively easy to compute using a quantum computer, whereas attempting to compute Gibbs states directly using the quantum computer is very difficult, and in many cases technically impossible or computationally intractable. Advantageously, embodiments are configured to compute “very general observables” representative of given Gibbs states, wherein the observables (M) are generated from a Hamiltonian and at a finite temperature (for example, at a non-zero temperature).

We have shown, for the scenario in which we wish to predict a total of M Gibbs state expectation values, that an order of log(M), namely O(log(M)), observations from a quantum circuit and/or experiments of a given real physical system are sufficient input parameters (in element 30 of FIG. 1) to train a computational engine, for example a quantum Boltzmann machine, using expectation values with additive error, and without a need to compute the Gibbs states directly (in element 40 of FIG. 1). In particular, by using thermal shadowing when generating the observables (M), the number of observables required can be reduced, and is of the order of log(M).

Such a relationship as used in implementations of the present disclosure represents a reduction in the number of observations (M) required compared to known earlier approaches. This reduction represents an advantage provided by embodiments of the concepts, techniques, and structures disclosed herein, for example requiring fewer qubits to be used in the quantum computer to perform a given computation, and also a reduced depth in quantum circuits used. Thus, there is provided a method using TPQ states that does not require purified Gibbs states to be prepared, which means a reduction in the number of qubits required in the one or more quantum computers 120 compared to other approaches. Other advantages result from not having to generate the Gibbs state on the one or more quantum computers 120, as known methods require many ancilla qubits and a deeper circuit. Thus, by using these thermal pure states (without the shadow), savings are made in the number of qubits required and quantum circuit depth.

We have also shown that it is sufficient to initialize an algorithm with a quantum 2-design, which implies that a quantum circuit depth of a first subroutine in the algorithm (namely, a random pure state preparation) can be reduced from exponential (Haar random) to polynomial (Clifford random). Such a reduction in quantum circuit depth reduces computational noise and therefore provides an improved accuracy in the observables (M) representative of Gibbs states as used in training a corresponding computation machine, for example for training a quantum Boltzmann machine. These random pure states are then imaginary time evolved and randomly measured to construct shadows. The aforesaid method is referred to as utilizing “Pure Thermal Shadows”.

Embodiments therefore may include a quantum circuit that implements Pure Thermal Shadows with Quantum Signal Processing and random Clifford circuits for use in the implementations. Such an approach does not suffer from barren plateaus, can in principle deal with any Hamiltonian, and allows to trade off between quantum circuit depth and quantum computational accuracy. These are all advantages compared to other known methods such as variational quantum algorithms. It will be appreciated that there is assumed use of a fault-tolerant quantum computer for the one or more quantum computers 120. Finally, numerical simulation results of the efficiency of the quantum circuit for a 10-spin ½ XXZ-Heisenberg model have been demonstrated in implementations of the present disclosure.

With reference to FIG. 3, Gibbs states are mixed quantum states of a form ρ_{β}=e^{-βH}/Z, where H is a system Hamiltonian, β is an inverse temperature, and Z=Tre^{-βH} is a partition function. These theoretical Gibbs states describe quantum systems in thermodynamic equilibrium with their environment at a finite temperature, and play a central role in quantum statistical mechanics. Their properties are of importance for a wide range of applications including the design of complex quantum materials in condensed matter physics and quantum chemistry, optimization with quantum semi-definite programming, and machine learning with quantum Boltzmann machines. An illustrative Gibbs state for a particular quantum system in thermal equilibrium with its environment is shown on the left-hand side of FIG. 3 (top).

Preparing Gibbs states and computing Gibbs state expectation values are highly non-trivial tasks. Existing known algorithms can have rather complicated implementations and may apply only to a limited set of systems. Classical algorithms suffer from the intractability of the partition function, resulting from the exponentially growing Hilbert space, or have a sign problem for some fermionic systems. Fault-tolerant quantum algorithms have better asymptotic scaling, but are limited by current hardware constraints and error processes. Variational quantum algorithms can prepare Gibbs states and cope with some hardware limitations, but require many experimental measurements for each optimization step and may suffer from barren plateaus in respect of their convergence during computation. Using variation quantum algorithms is therefore not a desirable approach. Other quantum approaches based on minimally entangled typical thermal states (METTS) set up a Markov chain that potentially has a long thermalization time. There arises therefore a need for more efficient ways to compute expectation values, namely observables (M), that are representative of the Gibbs states.

The present disclosure provides a more efficient quantum algorithm for estimating observables (M) representative of a large number of Gibbs state expectation values, but without preparing and measuring a corresponding true Gibbs state. Computing true Gibbs states is computationally complex, and in some cases intractable.

Estimation of observables (M) corresponding to a large number of Gibbs state expectation values is achieved in accordance with embodiments by combining thermal pure quantum states and classical shadow tomography in implementations of the present disclosure, as shown on the right-hand side of FIG. 3 (top). One way to generate a thermal pure quantum (TPQ) state is by using imaginary time evolution, e^{-βH/2}|ϕ [symbol] , of a n-qubit random state |ϕ [symbol] . It may be shown that, if the probability distribution over the initial states, |ϕ [symbol] , forms at least a quantum 2-design, the imaginary time evolved states are able to approximate the expectation values of ρ_{β} up to an error that falls off exponentially with the system size, n. Classical shadow tomography is then exploited to construct an efficient classical representation of these TPQ states from outcomes of randomized observations. For sufficiently large systems, the number M of Gibbs state expectation values may be estimated using [symbol] (log M) observations, namely measurements, of a single prepared TPQ state. This is a remarkable result because the required number of measurements is similar to the case where the Gibbs state is actually prepared (e.g. via a purification using 2n qubits). For embodiment of the present disclosure, a practical implementation of the algorithm is described below.

A suitable algorithm for configuring the one or more quantum computers 120 to compute the pure thermal shadow has three steps. A first step of the algorithm includes preparing an initial state using a polynomial-depth Clifford quantum circuit. This preparation suffices to produce a quantum 3-design.

A second step of the algorithm includes approximating the imaginary time evolution using quantum signal processing (QSP). This approach is very general (i.e. it applies to any quantum Hamiltonian H, in principle) and offers great flexibility since it is feasible to systematically trade off quantum circuit depth for quantum computational accuracy.

In a third step, for the randomized measurement, there is used another Clifford circuit. The complete circuit, comprising a Clifford circuit, a QSP circuit, and the randomized measurement, is shown in FIG. 3 (bottom). This circuit has a total number of qubits that is linear in the system size, n. Optionally, it is feasible to numerically simulate this quantum circuit for a quantum system of 10 spin-½ particles in the XXZ-Heisenberg model for implementations of the present disclosure.

A TPQ state is any pure state, |ϕ [symbol] , that is able to estimate a fixed set of properties (expectation values) of a sufficiently large mixed thermal state specified by some specific statistical ensemble. For the thermodynamic (canonical) Gibbs ensemble, it is defined to be any pure state |ϕ [symbol] which is drawn at random and that satisfies

Pr[| [symbol] ψ|Oⱼ|ψ [symbol] −Trρ_{β}Oⱼ|≥ϵ]≤C_{ϵ}e^{-αn}, (1)

for all Oⱼ in some predefined set of Hermitian operators {Oⱼ}. For the thermal pure quantum states, the observables Oⱼ beneficially have an operator norm that is at maximum polynomially large in the system size.

It will be appreciated that the pure states,

$$\vert {ψ}_{β} 〉 = \frac{{e}^{- β H / 2} U \vert 0 〉}{\sqrt{〈 0 \vert {U}^{†} {e}^{- β H} U \vert 0 〉}} ≡ \frac{{e}^{- β H / 2} U \vert 0 〉}{\sqrt{𝒩}} , \qquad ( 2 )$$

where U∈Cl(2ⁿ) is a random unitary drawn from the n-qubit Clifford group, satisfy Eq. (1). These TPQ states are different from the ones that are previously known. Use of a particular form of Haar random states for U|0 [symbol] is known to be used, which on a quantum computer would require exponential circuit depth. For implementations of the present disclosure, however, a choice of U˜Cl(2ⁿ) yields a unitary 3-design and thus it replicates Haar integrals up to the third moment. This is sufficient for purposes of use in implementations of the present disclosure and has the advantage of requiring only [symbol] (n²/log n) quantum gates.

The expectation value of an arbitrary Hermitian operator O in the random pure states |ψ_{β} [symbol] is, on average,

[symbol]

_{U} [symbol] ψ_{β}|O|ψ_{β} [symbol] ≈Trρ_{β}O+Trρ_{β}²(Trρ_{β}O−Trρ_{2β}O). (3)

Here, [symbol] _{U} denotes the ensemble average with respect to the n-qubit Clifford group U∈ [symbol] l(2ⁿ). This approximate expression is obtained from a Taylor expansion up to first order in Var [symbol] ; this is to take care of the appearance of U in the normalization constant [symbol] of |ψ_{β} [symbol] . The expansion is justified since Var [symbol] is exponentially small in n.

A similar expansion and calculation for the variance of the expectation value with respect to U yields

$$Var 〈 {ψ}_{β} \vert O \vert {ψ}_{β} 〉 \approx Tr {ρ}_{β}^{2} ( \frac{{Tr ( O {e}^{- β H} )}^{2}}{{Tre}^{- 2 β H}} - 2 Tr {ρ}_{2 β} OTr {ρ}_{2 β} O + {( Tr {ρ}_{β} O )}^{2} ) . \qquad ( 4 )$$

Both the bias in Eq. (3) and the variance in Eq. (4) are proportional to the purity of the Gibbs state, Trρ_{β}². Since the Gibbs state ρ_{β} minimizes the Helmholtz free energy, F_{β}=−log Z/β, there may be written,

$$Tr {ρ}_{β}^{2} = \frac{{Tre}^{- β H}}{{Z}^{2}} = {e}^{- 2 β ( {F}_{2 β} - {F}_{β} )} = 𝒪 ( {e}^{- n} ) . \qquad ( 5 )$$

The last equality follows from properties of the free energy, i.e., the extensivity, F_{β}∝n, and the monotonicity with respect to the inverse temperature, F_{2β}>F_{β}.

The terms that multiply the purity in Eqs. (3) and (4) have the form of expectation values and can be bounded by the spectral norm, ∥O∥². This means that for operators with polynomially large ∥O∥², the variance vanishes exponentially with n. After application of a Markov inequality, it is found find that |ψ [symbol] =|ψβ [symbol] satisfies Eq. (1) with C_{ϵ}=4∥O∥²/ϵ² and αn=2β(F_{2β}−F_{β}).

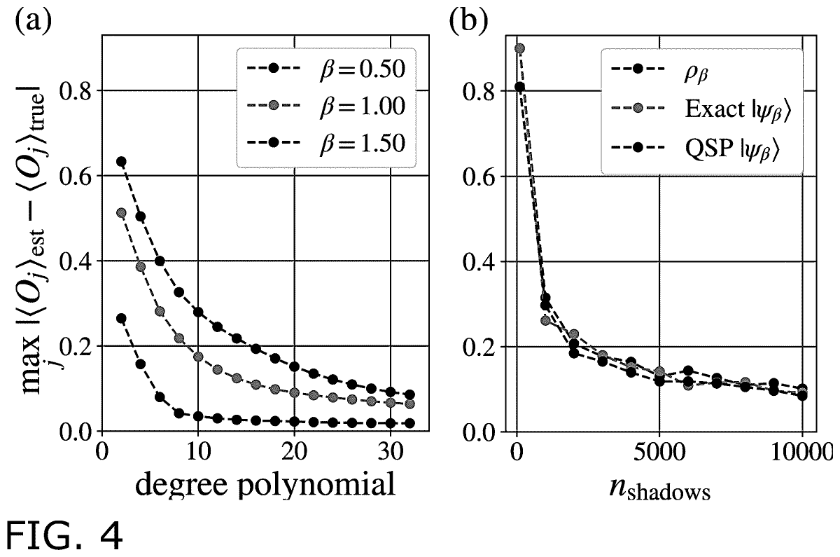

Thus, in accordance with embodiments of the concepts, techniques, and structured disclosed herein, the expectation values of O with respect to the random pure states |ψ_{β} [symbol] may be used as estimators for Gibbs state expectation values of polynomially sized operators O for sufficiently large systems and finite β. Maximum error between the exact Gibbs state expectation values and the expectation values estimated in accordance with embodiments, as a function of the degree of the polynomial, is shown in FIG. 4(a).

Importantly, for β|=∞, i.e. when the Gibbs state approaches the ground state of H, the Gibbs state becomes pure, Trρ_{β}²=1, and the error remains finite for any system size n. For all other β, the rate of exponential decay, and thus how large n needs to be, is dictated by F_{2β}−F_{β}. The exact error therefore depends on which specific system Hamiltonian H that is being considered, the inverse temperature β, and also the spectral norm of the observable ∥O∥. This means that in some specific instances using only a single TPQ state is sufficient (for example, as used in some implementations of the present disclosure). In contrast, known prior approaches that do not have a vanishing variance, such as algorithms based on METTS, may require multiple pure states to be computed and may potentially become computationally intractable.

In order to implement the thermal shadow algorithm on a quantum device, a few different elements are needed as follows. First, a method is used to sample uniformly from the n-qubit Clifford group to generate the random Clifford circuits U. An efficient, polynomial time, algorithm exists for this, which has been implemented in an algorithm of a quantum computing library. This algorithm is used for both the generation of the random pure states at the beginning of the algorithm as well as the randomized measurements at the end of the algorithm.

Next, there is used a routine to approximate the non-unitary operator e^{-βH/2} in Eq. (2). To this end, there is used quantum signal processing (QSP), namely a framework for performing matrix arithmetic operations on quantum computers. Intuitively, QSP applies a target polynomial to the eigenvalues of a block-encoded matrix. It is assumed that the Hamiltonian is given in the form H=ΣₖaₖPₖ where aₖ∈ [symbol] and Pₖ are n-qubit Pauli operators. To begin, there is used a pre-processing step that rescales the spectrum of H to the interval [0, 1]. This allows to block-encode the re-scaled Hamiltonian into a larger unitary matrix. Beneficially, there may use a min-max re-scaling \tilde{H}=(H−λₘᵢₙ [symbol] )/(λₘₐₓ−λₘᵢₙ) where λₘᵢₙ (λₘₐₓ) is the smallest (respectively largest) eigenvalue. This rescaling avoids squeezing the eigenvalues in an interval much smaller than [0, 1], which in turn may lead to larger approximation errors.

In practice, the extremal eigenvalues are unknown and it is necessary to resort to a lower bound for λₘᵢₙ and to an upper bound for λₘₐₓ. The imaginary time τ=β(λₘₐₓ−λₘᵢₙ)/2 is defined so that

e^{-τ\tilde{H}}=e^{βλ}^{ₘᵢₙ}^{/2}e^{-βH/2}. (12)

Thus, it is feasible to evolve \tilde{H} for time τ and obtain the desired non-unitary operator up to a constant factor. This factor is irrelevant as it cancels out in Eq. (2). The spectrum of \tilde{H} is then transformed using a polynomial approximation to the even function e^{-\check{τ}|x|}. The absolute value simplifies the polynomial approximation since the polynomial will be even.

For example, a polynomial may be found using the Python pyqsp library to construct a suitable QSP circuit. QSP makes [symbol] (\sqrt{β(λₘₐₓ−λₘᵢₙ)} log(1/ϵ)) uses of the block-encoding circuit. At the bottom of FIG. 3 is shown the circuit diagram where QSP is used to produce a TPQ state in Eq. (2). The success probability depends on the initial random state, and has a value of [symbol] (e^{βλ}^{ₘᵢₙ}Tre^{-βH}/2n) on average. It can be verified that the expected success probability decreases as β increases. This is expected from the intuition that low-temperature sampling is harder.

In order to enhance this probability, fixed-point amplitude amplification is used, as there is no coherent algorithm for imaginary time evolution. With [symbol] (e^{-βλmin} [symbol] \sqrt{2ⁿ/Tre^{-βH}}) iterations of amplitude amplification, the protocol is expected to succeed with probability [symbol] (1). This can be implemented via yet another layer of QSP. This protocol works with any Hamiltonian and temperature provided that a suitable block-encoding circuit is found. However, it will be appreciated that the circuit depth is expected to be polynomial in n only for certain choices of H and β. In FIG. 4(b) are shown the errors between shadows constructed directly from the true Gibbs state, ρ_{β}, shadows constructed from the exact TPQ states, and the TPQ states generated with QSP, as a function of the number of shadows.

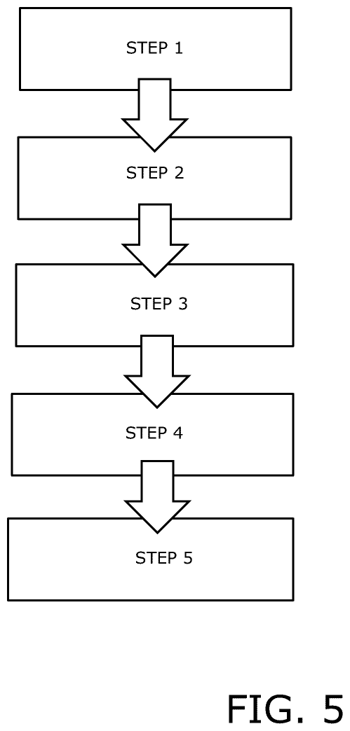

Summarizing the foregoing, the present disclosure provides a method for generating and using a mathematical model in at least one of monitoring, optimizing and controlling a given real physical system. The method includes follows steps as illustrated in FIG. 5.

STEP 1: Obtain data that represents operation of the real physical system.

STEP 2: Generate at least one Hamiltonian and generate therefrom a quantum circuit using thermal pure quantum (TPQ) states and thermal shadows, wherein M observables obtainable from executing the quantum circuit on a quantum computer are representative of Gibbs states, wherein the M observables representative of the Gibbs states involve using a combination of thermal pure quantum (TPQ) states and classical shadow tomography.

STEP 3: Use the M observables to train a computational machine, for example a quantum Boltzmann machine.

STEP 4: Incorporate the computational machine into a mathematical model that describes operation of the real physical system.

STEP 5: Apply the mathematical model to the real physical system for at least one of monitoring, optimizing and controlling the real physical system. Optionally, such an optimization may be achieved by using a variational quantum eigensolver (VQE) method.

Optionally, the thermal pure quantum (TPQ) states are generated by using imaginary time evolution, e^{-βH/2}|ϕ [symbol] , of a n-qubit random state |ϕ [symbol] . It may be shown that, if the probability distribution over the initial states, |ϕ [symbol] , forms at least a quantum 2-design, the imaginary time evolved states are able to approximate the expectation values of ρ_{β} up to an error that falls off exponentially with the system size, n.

Optionally, classical shadow tomography is used to construct an efficient classical representation of these TPQ states from outcomes of randomized measurements. Optionally, for sufficiently large systems, M Gibbs state expectation values may be estimated using [symbol] (log M) measurements of a single prepared TPQ state. This is remarkable result because the required number of observables is similar to the case where there is actually prepared the Gibbs state (e.g. via a purification using 2n qubits).

It will be appreciated that a quantum Boltzmann machine is a natural application of the thermal shadow algorithm pursuant to the present disclosure. Such a machine is an example of how the algorithm can be used to solve a specific set of problems, which are Hamiltonian Learning and Generative Modelling problems in implementations of the present disclosure.

A quantum Boltzmann machine learns a parameter of a Hamiltonian that, at a given temperature, produces samples matching an input data distribution. The quantum Boltzmann machine is trained in an iterative process that roughly speaking comprises at least two steps. The first step comprises, for fixed Hamiltonian parameters, collecting samples to assess how well the model Hamiltonian fits input data representative of operation of the real physical system, for example obtained from experimental measurements made on a real physical system. The second step comprises updating the Hamiltonian parameters according to an update rule, wherein such updating may be implemented efficiently with shadows of pure thermal sates, wherein updating Hamiltonian parameters requires computing certain observables of the Gibbs states. However, it will be appreciated that use of a quantum Boltzmann machine is merely an example.

Importantly, the present disclosure includes use of a method that provides a solution to a problem having several requirements. The first requirement is that a given quantum system is in thermodynamical equilibrium with an environment, wherein the environment is defined in a Hamiltonian and a finite temperature. The second requirement is that a given set of observables is provided from the given quantum system, from which there is required to be computed expectation values over the system previously specified. The third requirement is that the computation is required to be executed accurately and efficiently in three ways.

The first computational requirement is reducing the number of samples as compared to an exponential function in the system size and linear function in the number of observables. The second computational requirement is reducing the number of qubits needed as compared to linear or worse overheads in quantum circuit ancilla qubits as a function of the system size. And the third computational requirement is reducing the quantum circuit depths as compared to an exponential function of the system size.

The solution to the aforesaid problem includes computing the M observables values using classical shadows of Thermal Pure Quantum (TPQ) states, as described in the foregoing. The M observables are used, for example to train a quantum Boltzmann machine, as aforementioned.

As a corollary, it will be appreciated that the pure thermal state may generally be prepared using quantum signal processing, wherein certain implementation details depend on characteristics of the real physical system. Moreover, it will be appreciated that another use application of implementations of the present disclosure requires computing some observables of a Gibbs state, namely as in Quantum Semi Definite Programming (QSDP); such programming is conceptually disjoint.

To control a given real physical system using the aforesaid mathematical model including the computational engine in STEP 5, the given real physical system is provided with at least one feedback control loop. One or more parameters for the control loop are generated by the mathematical model. Input parameters relative to output parameters of the control loop are monitored as a function of time, and temporal drift in the parameters may be used to determine a state of the real physical system. The state of the real physical system may be, for example, sub-optimal operating conditions of the real physical system, imminent component failure of the real physical system, a need to do maintenance on the real physical system (to improve its reliability), and so forth.

Modifications to embodiments of the disclosure described in the foregoing are possible without departing from the scope of the disclosure as defined by the accompanying claims. Expressions such as “including”, “comprising”, “incorporating”, “have”, “is” used to describe and claim the disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the disclosure, which are, for clarity, described in the context of separate embodiments, may also be provided in combination in a single embodiment. Conversely, various features of embodiments, which are, for brevity, described in the context of a single embodiment, may also be provided separately or in any suitable combination or as suitable in any other described embodiment of the disclosure.

Although reference is made herein to particular materials, it is appreciated that other materials having similar functional and/or structural properties may be substituted where appropriate, and that a person having ordinary skill in the art would understand how to select such materials and incorporate them into embodiments of the concepts, techniques, and structures set forth herein without deviating from the scope of those teachings.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. An apparatus for at least one of optimizing, monitoring and controlling a real physical system, wherein the apparatus includes a hybrid computing arrangement including one or more classical computers coupled to one or more quantum computers, wherein the one or more quantum computers are configured to execute one or more quantum circuits that are configured using the one or more classical computers, wherein the apparatus is configured in use to:
(i) obtain data that are representative of operation of the real physical system;
(ii) use the data to generate one or more Hamiltonians to define at least one quantum circuit that is executable on the one or more quantum computers, wherein observables (M) obtained from executing the at least one quantum circuit are representative of Gibbs states and wherein generation of the observables (M) includes using a combination of thermal pure quantum (TPQ) states and classical shadow tomography;
(iii) train a computational machine based on the observables (M) representative of the Gibbs states;
(iv) generate a mathematical model representative of the real physical system including the computational machine; and
(v) apply the mathematical model to data obtained from the real physical system for generating at least one of:
(a) a monitoring output that is representative of an operating state or operating condition of the real physical system;
(b) one or more inputs to an optimization function applied to the mathematical model to generate values of parameters to use to operate the real physical system in a more optimized manner; and
(c) one or more inputs to a control function applied to the mathematical model to generate values of parameters to use to control operation of the real physical system.

2. The apparatus of claim 1, wherein the apparatus is configured to generate the thermal pure quantum (TPQ) states by using imaginary time evolution, e^{-βH/2}|ϕ [symbol] of a n-qubit random state |ϕ [symbol] .

3. The apparatus of claim 1, wherein the apparatus is configured to use the classical shadow tomography to construct an efficient classical representation of these TPQ states from outcomes of randomized subset of the (M) observables.

4. The apparatus of claim 1, wherein the apparatus is configured to estimate M Gibbs state expectation values using [symbol] (log M) observables of a single prepared TPQ state.

5. A method for using an apparatus for at least one of optimizing, monitoring and controlling a real physical system, wherein the apparatus includes a hybrid computing arrangement including one or more classical computers coupled to one or more quantum computers, wherein the one or more quantum computers are configured to execute one or more quantum circuits that are configured using the one or more classical computers, wherein the method includes:
(i) obtaining data that are representative of operation of the real physical system;
(ii) using the data to generate one or more Hamiltonians to define at least one quantum circuit that is executable on the one or more quantum computers, wherein observables (M) obtained from executing the at least one quantum circuit are representative of Gibbs states (namely, statistical distributions) and wherein generation of the observables (M) includes using a combination of thermal pure quantum (TPQ) states and classical shadow tomography;
(iii) training a computational machine based on the observables (M) representative of the Gibbs states;
(iv) generating a mathematical model representative of the real physical system including the computational machine; and
(v) applying the mathematical model to data obtained from the real physical system for generating at least one of:
(a) a monitoring output that is representative of an operating state or operating condition of the real physical system;
(b) one or more inputs to an optimization function applied to the mathematical model to generate values of parameters to use to operate the real physical system in a more optimized manner; and
(c) one or more inputs to a control function applied to the mathematical model to generate values of parameters to use to control operation of the real physical system.

6. The method of claim 5, wherein the method includes using the apparatus to generate the thermal pure quantum (TPQ) states by using imaginary time evolution, e^{-βH/2}|ϕ [symbol] of a n-qubit random state |ϕ [symbol] .

7. The method of claim 5, wherein the method includes using the classical shadow tomography to construct an efficient classical representation of these TPQ states from outcomes of randomized subset of the (M) observables.

8. The method of claim 5, wherein the method includes estimating M Gibbs state expectation values using [symbol] (log M) observables of a single prepared TPQ state.

9. A quantum mechanical apparatus comprising:
one or more classical computers coupled to a real physical system; and
one or more quantum computers in data communication with the one or more classical computers;
wherein the one or more quantum computers comprise a plurality of qubits configured to perform a quantum circuit that includes:
(a) a first Clifford circuit configured to randomize a thermal pure quantum state |ϕ [symbol] of the plurality of qubits,
(b) a quantum signal processing circuit configured to approximate an imaginary time evolution of |ϕ [symbol] according to one or more Hamiltonians representative of the real physical system, and
(c) a second Clifford circuit configured to perform a randomized measurement of |ϕ [symbol] to thereby compute one or more observables representative of Gibbs states;
wherein the one or more classical computers are configured to control the real physical system on the basis of the computed one or more observables.

10. The quantum mechanical apparatus according to claim 9, wherein the one or more quantum computers further comprise a quantum Bayesian machine coupled to the quantum circuit for training by the one or more computed observables.

11. The quantum mechanical apparatus of claim 10, wherein the quantum Bayesian machine comprises a Boltzmann machine, or a Born machine, or an Ising machine.

12. The quantum mechanical apparatus according to claim 10, wherein the one or more quantum computers are configured to provide, to the one or more classical computers, a classical representation of a state of the real physical system by applying classical shadow tomography to the quantum Bayesian machine.
